(19) United States
(12) Patent Application Publication
(10) Pub. No.: US 2026/0082455 A1
(43) Pub. Date: Mar. 19, 2026

(54) RECHARGEABLE BATTERY-INTEGRATED INDUCTION RANGE

(71) Applicant: SOLON CO., LTD., Yongin-si, Gyeonggi-do (KR)

(72) Inventor: Seok Ju OH, Yongin-si (KR)

(73) Assignee: SOLON CO., LTD., Yongin-si, Gyeonggi-do (KR)

(21) Appl. No.: 19/148,909

(22) PCT Filed: Feb. 7, 2023
(86) PCT No.: PCT/KR2023/001690

§ 371 Date: Jul. 17, 2025

(30) Foreign Application Priority Data
Jan. 17, 2023 (KR) 10-2023-0006818

(51) Int. Cl. H05B 6/12; H01M 10/613; H01M 10/6554; H01M 10/6563; H05B 6/04; H05B 6/42

(52) U.S. Cl. CPC H05B 6/1209; H01M 10/613; H01M 10/6554; H01M 10/6563; H05B 6/04; H05B 6/42

(57) ABSTRACT

The present invention relates to an induction range and, particularly, to a rechargeable battery-integrated induction range which can keep a rechargeable battery at room temperature and minimize power consumption. The rechargeable battery-integrated induction range of the present invention comprises: an induction module for heating a top plate by induction heating; and a power module having a battery pack therein and coupled to the bottom side of the induction module and, the battery pack being capable of supplying the induction module with direct current power for induction heating, wherein the induction module and the power module are coupled to each other such that at least portions corresponding to the battery pack are spaced apart from each other.

### TECHNICAL FIELD

The present invention relates to an induction range, and more particularly, to a rechargeable battery-integrated induction range of which a rechargeable battery can be maintained at room temperature and power consumption can be minimized.

### BACKGROUND ART

In general, a chafing dish is a vessel that applies heat to food and maintains a temperature of the food so as to prevent hot food from getting cold in restaurants such as banquet halls and buffets. Conventionally, butane gas, alcohol, or solid fuel has been used to heat the dish, but the use thereof is restricted due to the risk of fire caused by the use of flames.

Induction ranges are widely used as a solution for such a problem, but currently commercialized induction ranges are operated by AC power and thus should include AC power cords. These AC power cords are taped and wired on a floor of a place where food is served, which not only spoils the beauty but also has a safety hazard.

Meanwhile, since induction ranges typically use a high power such as 300 Wh or more, even when a battery with predetermined capacity is used as an independent power source, the induction ranges can only be used for a short time and thus have a limitation in use. In addition, in induction ranges that use batteries charged with DC power, due to high heat generated in an upper plate when the induction ranges operate, battery performance is considerably reduced, and a lifetime is rapidly shortened, and since high power consumption is required, the integration with a battery is practically very difficult.

### DISCLOSURE

### Technical Problem

The present invention is directed to solving the above problems and providing a rechargeable battery-integrated induction range which allows the impact on a battery due to high heat generated from an upper plate thereof to be minimized when an induction range operates, thereby allowing the battery to maintain at room temperature.

The present invention is also directed to providing a rechargeable battery-integrated induction range which is usable for a long time with a rechargeable battery with predetermined capacity because heat of an upper plate thereof heated to a predetermined temperature may be maintained to minimize the power consumption of a battery.

### Technical Solution

In order to achieve the above object, a rechargeable battery-integrated induction range according to the present invention includes an induction module configured to heat an upper plate through an induction heating method, and a power module coupled to a lower side of the induction module and including a battery pack, which allows DC power for induction heating to be supplied to the induction module, provided therein, wherein the induction module and power module are coupled to each other such that at least portions thereof corresponding to the battery pack are spaced apart from each other.

In addition, a radiant heat blocking sheet for blocking radiant heat may be provided in a separation space between a lower surface of the induction module and an upper surface of the power module.

In addition, the induction module may include a blower fan, which cools an inside thereof, therein, a suction passage through which external air is introduced may be formed in a separation space formed between the induction module and the power module as the induction module and the power module are coupled, and air introduced into the suction passage through driving of the blower fan may pass through the inside of the induction module and may be discharged to the outside.

In addition, the blower fan may be provided at a rear end portion of the induction module such that a suction port is exposed at a lower surface of the induction module, an inlet of the suction passage may be formed between a front end of the induction module and a front end of the power module, and suction passage guides, which form the suction passage configured to move air introduced through the inlet of the suction passage to the suction port, may be provided in the lower surface of the induction module and an upper surface of the power module to correspond to each other.

In addition, the induction module may further include an energy conservation sheet which is provided at a lower side adjacent to the upper plate and allows heat of the upper plate, which is heated to a predetermined temperature, to be maintained.

### Advantageous Effects

Even when a power module including a battery pack, which is charged with DC power to supply the DC power to an induction module, is integrated with the induction module, since at least portions, which correspond to the battery pack, of the induction module and the power module are spaced apart from each other, heat generated when the induction module operates can be prevented from being conducted to the battery pack.

In addition, the impact on a power module due to radiant heat from an induction module can be blocked by a radiant heat blocking sheet provided between the induction module and the power module, and external air can pass through a suction passage between the induction module and the power module to enter the induction module through the driving of the blower fan so that heat transfer through convection can also be blocked.

In this way, since the impact on a power module due to heat generated by the operation of an induction module through conduction, radiation, or convection can be effectively prevented, even when the induction module integrated with the power module operates at a high temperature, a battery pack installed in the power module can be maintained at room temperature.

The heat of an upper plate heated to a predetermined temperature can be maintained through an energy conservation sheet to minimize the power consumption of a battery pack so that an induction module can operate for a long time even with a rechargeable battery pack having predetermined capacity.

Accordingly, according to the present invention, it is possible to commercialize an induction range that does not require an AC power cord, thereby improving the convenience and portability of induction cookers.

### DESCRIPTION OF DRAWINGS

FIGS. 1 and 2 are perspective views illustrating a rechargeable battery-integrated induction range according to the present invention.

FIG. 2 is an exploded perspective view illustrating the rechargeable battery-integrated induction range according to the present invention.

FIG. 3 is a perspective view illustrating a lower surface of an induction module case including a blower fan applied to the rechargeable battery-integrated induction range according to the present invention.

FIG. 4 is a perspective view illustrating an upper surface of the induction module case including the blower fan applied to the rechargeable battery-integrated induction range according to the present invention.

FIG. 6 is a plan view illustrating lower and upper surfaces of the induction module case applied to the rechargeable battery-integrated induction range according to the present invention.

FIG. 7 is a plan view illustrating air flow in the induction module case including the blower fan applied to the rechargeable battery-integrated induction range according to the present invention.

FIG. 8 is a perspective view illustrating an upper surface of a power module cover applied to the rechargeable battery-integrated induction range according to the present invention.

FIG. 9 is a plan view illustrating a state in which a radiant heat blocking sheet is coupled to an upper surface of the power module cover applied to the rechargeable battery-integrated induction range according to the present invention.

### MODES OF THE INVENTION

In order to maintain a rechargeable battery at room temperature and minimize power consumption, the present invention proposes a rechargeable battery-integrated induction range including an induction module configured to heat an upper plate through an induction heating method, and a power module coupled to a lower side of the induction module and including a battery pack, which is capable of supplying DC power for induction heating to the induction module, provided therein, wherein the induction module and the power module are coupled to each other such that at least portions thereof corresponding to the battery pack are spaced apart from each other.

The scope of the present invention is not limited to embodiments described below, and various modifications may be made by a person having ordinary knowledge in the art without departing from the technical spirit of the present invention.

Hereinafter, a rechargeable battery-integrated induction range according to the present invention will be described in detail with reference to the accompanying drawings 1 to 9.

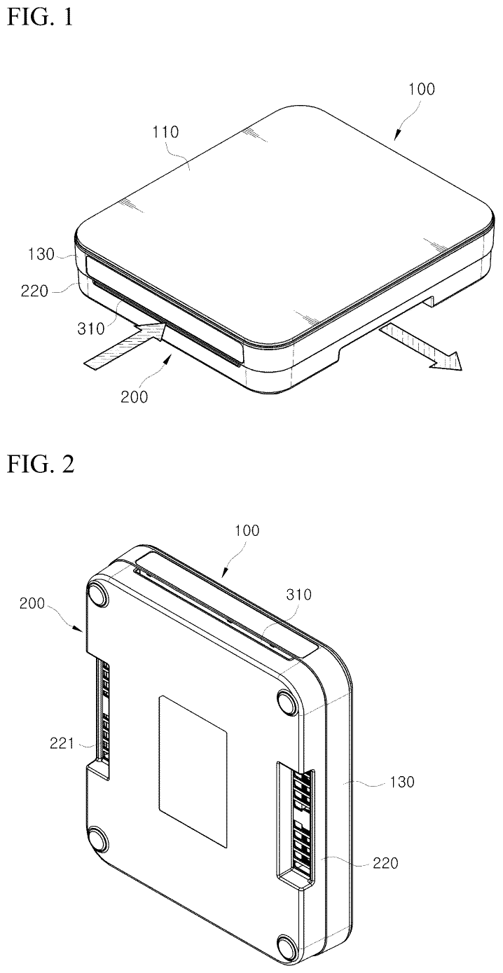

As shown in FIGS. 1 to 3, the rechargeable battery-integrated induction range of the present invention includes an induction module 100 that heats an upper plate 110 through an induction heating method, and a power module 200 that is coupled to a lower side of the induction module 100 and includes a battery pack 210, which is capable of supplying DC power for induction heating to the induction module 100, provided therein.

The induction module 100 may include a resonance coil for induction heating and an induction heating control unit therein, and the resonance coil and the induction heating control unit may be regarded as internal heat sources that generate heat in the induction module 100. The upper plate 110 may be formed in a plate shape such that a cooking vessel may be placed at an upper side and may be made of a ceramic material with excellent heat resistance and durability. The resonance coil and the induction heating control unit may be provided in an induction module case 130 with an empty inside and an open upper surface, and the upper plate 110 may be coupled to cover an upper surface of the induction module case 130 through an induction module cover 150. In the induction module 100, when power is supplied, a current may flow in the resonant coil to generate a magnetic field, and when a cooking vessel is placed on the upper plate 100 in a state in which the magnetic field is formed, an eddy current may be generated, and the eddy current meet the electric resistance of a metal constituting the cooking vessel to generate an induction heating phenomenon so that the cooking vessel may be heated.

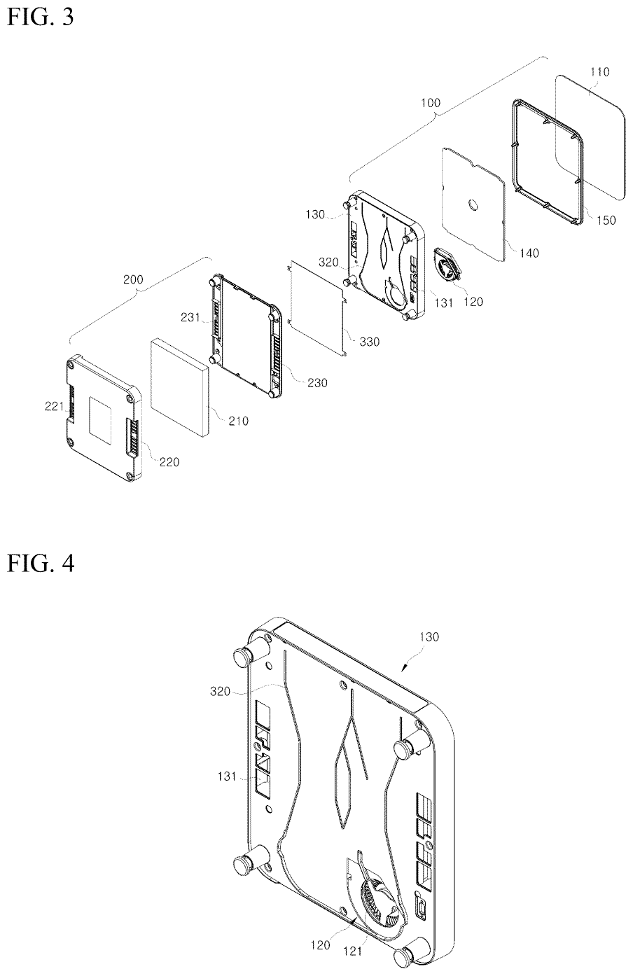

In addition, as shown in FIG. 3, the induction module 100 may further include an energy conservation sheet 140 that is provided at a lower side adjacent to the upper plate 100 and may preserve the heat of the upper plate 110 heated to a predetermined temperature. The energy conservation sheet 140 may include, for example, a mica sheet and insulating sheets disposed at upper and lower sides of the mica sheet, and the insulating sheet may be made of a wool material. The energy conservation sheet 140 may respond to a temperature of the upper plate 110 after a predetermined period of time for which the upper plate 110 is heated to a target temperature and may allow a temperature of the upper plate 110 to be maintained without additional heating, thereby minimizing the power consumption of the battery pack 210 that supplies power to the induction module 100. Accordingly, an induction range may be used for a long time with the battery pack 210 having predetermined capacity.

As shown in FIGS. 4 and 5, the induction module 100 includes a blower fan 120 for cooling the inside thereof. As an example, the blower fan 120 may be provided in the induction module case 130. In this case, a suction port 121 of the blower fan 120 may be provided to be exposed at a lower surface of the induction module case 130, which is a lower surface of the induction module 100, and an exhaust port 122 of the blower fan 120 may be provided to face the inside of the induction module case 130. Air flow through the blower fan 120 will be described in detail below when a suction passage 310 is described.

Meanwhile, the power module 200 includes the battery pack 210, which may be charged with DC power and may supply the charged DC power to the induction module 100, therein. As an example, as shown in FIG. 3, the power module 200 may include a power module case 220 with an empty inside and an open upper surface, the battery pack 210 provided inside the power module case 220, and a power module cover 230 covering an upper surface of the power module case 220.

Here, the battery pack 210 may include a charge jack that may be connected to a charger to receive DC power, a discharge jack that is for supplying DC power to the induction module 100, and a switch that is for preventing spontaneous discharging when the induction module 100 is not used. The battery pack 210 may be integrally installed in the power module 200 or may be separated from the power module 200 to be charged externally and then installed in the power module 200, and the power module 200 itself including the battery pack 210 may also be separated from the induction module 100 to be charged externally and then may be coupled to the induction module 100.

The induction module 100 and the power module 200 provided therebelow are coupled to each other such that at least portions thereof corresponding to the battery pack 210 are spaced apart from each other as shown in FIGS. 1 and 2. That is, the lower surface of the induction module 100 and an upper surface of the power module 200 may be spaced apart from each other at portions corresponding to the battery pack 210 provided inside the power module 200.

As an example, the upper surface of the power module 200, which excludes both edges thereof, may be recessed downward from a front end to a point adjacent to a rear end, and the battery pack 210 may be provided below a recessed portion of the upper surface of the power module 200. When the induction module 100 is coupled to an upper side of the power module 200, as at least portions corresponding to the battery pack 210 are separated from each other, the induction module 100 and the power module 200 are coupled to each other. Accordingly, since the upper surface of the power module 200 corresponding to the battery pack 210 provided therein is not in direct contact with the induction module 100, heat generated when the induction module 100 operates can be effectively prevented from being conducted to the battery pack 210.

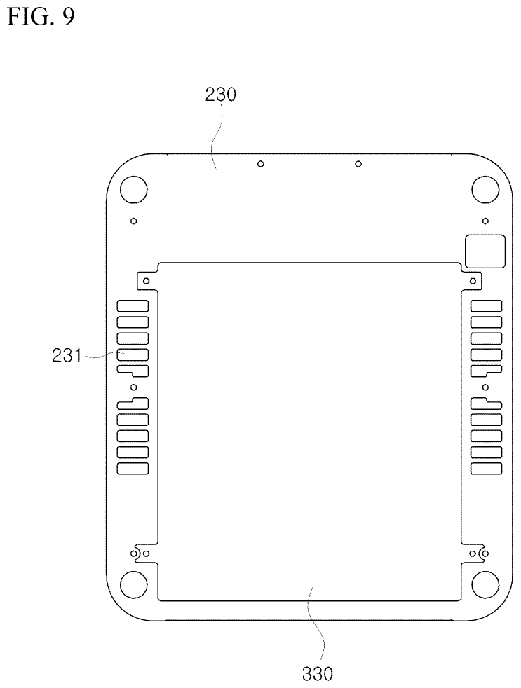

In addition, as shown in FIG. 3, a radiant heat blocking sheet 330 capable of blocking radiant heat may be provided in a separation space between the lower surface of the induction module 100 and the upper surface of the power module 200. As an example, the radiant heat blocking sheet 330 may be formed in a plate shape that at least corresponds to a size of the battery pack 210 as shown in FIG. 9, and an edge thereof may be coupled to an upper surface of the power module cover 230 to be provided between a suction passage guide 320 provided to protrude downward from the lower surface of the induction module case 130 and a suction passage guide 320 provided to protrude upward from the upper surface of the power module cover 230.

The radiant heat blocking sheet 330 can block the impact on the power module 200 due to radiant heat from the induction module 100. In addition, air flow may be formed in adjacent upper and lower sides of the radiant heat blocking sheet 330, and thus the radiant heat blocking sheet 330 may be self-cooled, thereby more effectively blocking radiant heat from being conducted to the power module 200.

The suction passage 310 through which external air may flow in may be formed in the separation space formed between the induction module 100 and the power module 200 as the induction module 100 and the power module 200 are coupled. As an example, the upper surface of the power module 200 may be recessed downward from the front end to a point adjacent to the rear end, excluding both edges, and when the induction module 100 is coupled to the upper side of the power module 200, the suction passage 310, of which an inlet is formed between a front end of the induction module 100 and the front end of the power module 200, may be formed.

Accordingly, when the blower fan 120 provided in the induction module 100 is driven, external air is introduced through the suction passage 310 and then enters the inside of the induction module case 130 through the exhaust port 122. In this case, it is preferable that when a flow of air introduced through the suction passage 310 and entering the suction port 121 pass through an upper side of a portion corresponding to the battery pack 210 provided inside the power module 200 and minimize the impact on the battery pack 210 due to heat generated from the induction module 100. Accordingly, it is preparable that the blower fan 120 be provided at a rear end portion of the induction module 100 such that the suction port 121 is exposed at the lower surface of the induction module 100 as shown in FIGS. 4 and 5.

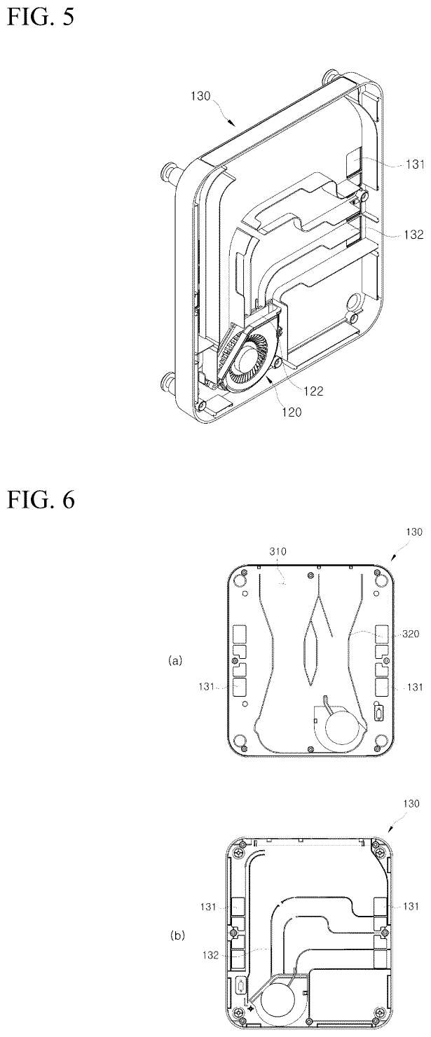

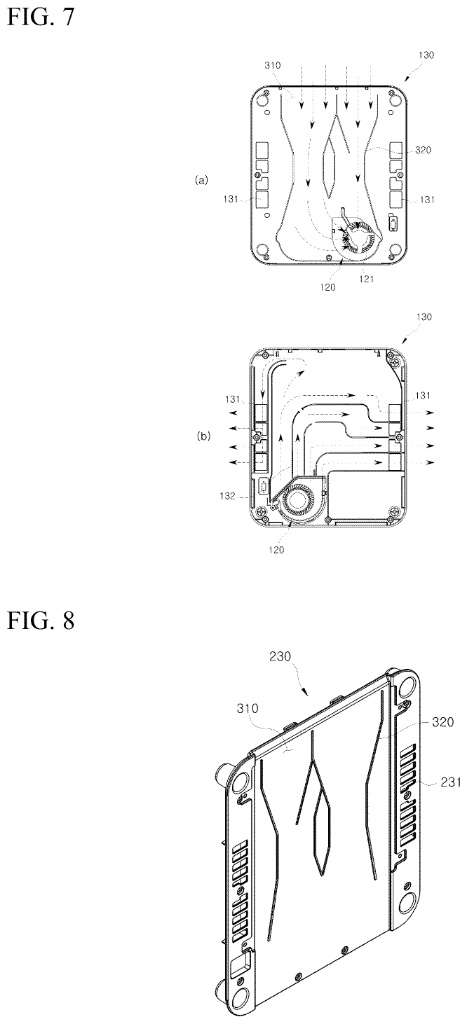

In addition, the suction passage guide 320, which forms the suction passage 310 for moving air introduced through the inlet of the suction passage 310 to the suction port 121, may be provided to protrude from each of the lower surface of the induction module 100 and the upper surface of the power module 200. That is, as shown in FIGS. 4, 6A, 7A, and 8, the suction passage guide 320 protruding downward from the lower surface of the induction module case 130 and the suction passage guide 320 protruding upward from the upper surface of the power module cover 230 may be formed in shapes corresponding to each other, and when the induction module 100 and the power module 200 are coupled, the two suction passage guides 320 arranged vertically may serve like one partition wall and may form the suction passage 310 thereinside.

The suction passage guide 320 serves as a guide for air introduced from the outside to move in the separation space between the induction module 100 and the power module 200. It is preferable that the suction passage 310 be formed to minimize the impact on a portion, in which the influence of heat is concentrated, due to heat. As an example, as shown in FIGS. 4, 6A, 7A, 7E, and 8, the suction passage guide 320 is provided to form a suction passage 310 that becomes narrower from the inlet of the suction passage 310 toward a portion corresponding to a thermal center of the battery pack 210, and form a suction passage 310 that becomes wider from the portion corresponding to the thermal center of the battery pack 210 toward the suction port 121, thereby maximizing an air speed at the portion corresponding to the thermal center of the battery pack 210. Here, the thermal center of the battery pack 210 may refer to a portion of the battery pack 210 in which the influence of heat is concentrated and may be a portion corresponding to a center of the resonance coil included in the induction module 100.

By driving the blower fan 120, external air may pass through the suction passage 310 between the induction module 100 and the power module 200 to enter the induction module 100. Heat transfer through convection may be blocked, and also the power module 200 may be cooled through air flow in the suction passage 310. Air that flows into the suction passage 310 to enter the suction port 121 through driving of the blower fan 120 flows into the induction module 100 through the exhaust port 122 and is discharged to the outside through the inside of the induction module 100.

In order for air flowing into the induction module case 130 through the exhaust port 122 to effectively cool the resonance coil and the induction heating control unit serving as heat sources inside the induction module case 130 and then escape to the outside, a discharge passage guide 132 that forms a discharge passage may be formed to protrude upward from the upper surface of the induction module case 130 as shown in FIGS. 5, 6B, and 7B. As an example, the discharge passage guide 132 may be formed from the exhaust port 122 to a point at which a first discharge hole 131 to be described below is formed, the inside of the induction module case 130 may be divided into a plurality of zones by the discharge passage guide 132, and air may cool the resonance coil or/and induction heating control unit that may be provided in each zone and then may be discharged through the first discharge hole 131. In this case, it is preferable that the plurality of zones divided by the discharge passage guide 132 have different widths and are formed as wide and narrow portions to change air flow to allow the heat sources such as the resonance coil and the induction heating control unit to be effectively cooled.

Since air that passes through the inside of the induction module 100 and is discharged to the outside has a relatively higher temperature than air that flows into the suction passage 310, it is preferable that the discharged air and the inflow air be not affected by each other. As an example, when air introduced through the suction passage 310 moves from the front to the rear, air discharged to the outside through the inside of the induction module 100 may be discharged laterally.

As a specific example, the first discharge holes 131 through which air passing through the inside of the induction module 100 is discharged may be formed in both sides of the lower surface of the induction module case 130, second discharge holes 231 and 221 corresponding to the first discharge holes 131 and communicating with the outside may be formed in the power module cover 230 and the power module case 220, and a portion of the power module case 220 in which the second discharge hole 221 is formed may be formed to be recessed upward. In this case, the portion of the power module 200 recessed upward may be formed to be open laterally, and thus air that flowing out to the outside through the first discharge hole 131 and the second discharge hole 221 and 231 may be discharged laterally.

As described above, according to the present invention, even when the power module 200 including the battery pack 210 charged with DC power is integrated with the induction module 100, it is possible to effectively prevent heat generated through the operation of the induction module 100 from affecting the power module 200 through conduction, radiation, or convection. Thus, even when the induction module 100 operates at a high temperature, the battery pack 210 provided in the power module 200 can be maintained at room temperature. In addition, the heat of the upper plate 110 heated to a predetermined temperature can be maintained through the energy conservation sheet 140 to minimize the power consumption of the battery pack 210 so that the induction module 100 can operate for a long time even with the rechargeable battery pack 210 having certain capacity. Accordingly, it is possible to commercialize an induction range that does not require an AC power cord, thereby improving the convenience and portability of induction cookers.

### DESCRIPTION OF REFERENCE NUMERALS

| | |
|---|---|
| 100: induction module | 110: upper plate |
| 120: blower fan | 121: suction port |
| 122: exhaust port | 130: induction module case |
| 131: first discharge hole | 132: discharge passage guide |
| 140: energy conservation sheet | 150: induction module cover |
| 200: power module | 210: battery pack |
| 220: power module case | 221: second discharge hole |
| 230: power module cover | 231: second discharge hole |
| 310: suction passage | 320: suction passage guide |
| 330: radiant heat blocking sheet | |

1. A rechargeable battery-integrated induction range comprising:
an induction module 100 configured to heat an upper plate 110 through an induction heating method; and
a power module 200 coupled to a lower side of the induction module 100 and including a battery pack 210, which allows DC power for induction heating to be supplied to the induction module 100, provided therein,
wherein the induction module 100 and power module 200 are coupled to each other such that at least portions thereof corresponding to the battery pack 210 are spaced apart from each other.

2. The rechargeable battery-integrated induction range of claim 1, wherein a radiant heat blocking sheet 330 for blocking radiant heat is provided in a separation space between a lower surface of the induction module 100 and an upper surface of the power module 200.

3. The rechargeable battery-integrated induction range of claim 1, wherein the induction module 100 includes a blower fan 120, which cools an inside thereof, therein,
a suction passage 310 through which external air is introduced is formed in a separation space formed between the induction module 100 and the power module 200 as the induction module 100 and the power module 200 are coupled, and
air introduced into the suction passage 310 through driving of the blower fan 120 passes through the inside of the induction module 100 and is discharged to the outside.

4. The rechargeable battery-integrated induction range of claim 3, wherein the blower fan 120 is provided at a rear end portion of the induction module 100 such that a suction port 121 is exposed at a lower surface of the induction module 100,
an inlet of the suction passage 310 is formed between a front end of the induction module 100 and a front end of the power module 200, and
suction passage guides 320, which form the suction passage 310 configured to move air introduced through the inlet of the suction passage 310 to the suction port 121, are provided in the lower surface of the induction module 100 and an upper surface of the power module 200 to correspond to each other.

5. The rechargeable battery-integrated induction range of claim 1, wherein the induction module 100 further includes an energy conservation sheet 140 which is provided at a lower side adjacent to the upper plate 110 and allows heat of the upper plate 110, which is heated to a predetermined temperature, to be maintained.

6. The rechargeable battery-integrated induction range of claim 1, wherein the power module 200 is separable from the induction module 100 so that the battery pack 210 is chargeable externally.
